(19) United States
(12) Patent Application Publication
(10) Pub. No.: US 2005/0080592 A1
(43) Pub. Date: Apr. 14, 2005

(54) Method and apparatus for evaluating the cognitive performance of an individual

(76) Inventors: Paolo Massimo Buscema, Rome (IT); Enzo Grossi, Milan (IT)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/493,735

(22) PCT Filed: Oct. 24, 2001
(86) PCT No.: PCT/IT01/00542

(51) Int. Cl. G06F 15/00

(52) U.S. Cl. 702/182

(57) ABSTRACT

A method for evaluating the cognitive performance of an individual by qualitative/quantitative analysis of the performance of a task, characterized in that: The task is a practical problem which may be exactly represented both graphically and mathematically and solved both graphically and computationally; The task has a set of solutions with a number of elements greater than one, one element being the best possible solution; And wherein the individual provides a graphical solution; Said graphical solution is converted into a numerical solution; A reference numerical solution is computed; The graphical solution converted into the numerical solution is compared with the computed reference numerical solution, a difference index being determined between the computed reference solution and the graphical solution proposed by the individual. The invention also relates to an apparatus for implementing said method.

The invention relates to a method for evaluating the cognitive performance of an individual by qualitative/quantitative analysis of the performance of a task.

Such methods are known and generally consist of a set of tests to be solved by an individual. The results of the tests are evaluated against criteria which are mostly generated by statistic experiences.

Prior art methods are widely used in a variety of fields, e.g. for personal use, scientific use or job assignment, to properly address individuals towards job types that are appropriate for their skills, or as a medical help to obtain initial information about the possible presence of cognitive skill disturbances.

However, currently used methods have drawbacks mainly consisting in the strong dependence of results from demographic parameters, such as the cultural and educational level of individuals, linguistic knowledge and other factors. As stated above, they are based on non strictly mathematical result evaluation criteria, whereby they may lead to non purely objective evaluations.

No method can currently obviate the above drawbacks, and allow at the same time an easy and fast implementation.

The invention is based on the problem of designing a method such as the one described above, which allows to obviate the shortcomings listed hereinbefore, is independent from the various demographic parameters, such as cultural and educational level and from the linguistic knowledge degree, and especially is based on strictly mathematical, hence objective result determination procedures.

The invention achieves the above purposes by providing a method as described hereinbefore, wherein the task is a practical problem and may be exactly represented both graphically and mathematically, solved both graphically and computationally, which task has a set of solutions with a number of elements greater than one, one element being the best possible solution, and wherein the individual provides a graphical solution and said graphical solution is compared with a best reference solution, at least one difference index between said best reference solution and said solution determined by the individual being computed from said comparison.

In a first embodiment, the problem is always the same and the best reference solution is precomputed.

An improvement may involve a finite set of different problems, their respective best reference solutions being precomputed or known.

This allows to prevent a certain performance improvement effect, caused by the repetition of the same problem several times, i.e. based on a certain experience accumulation.

In this case, the comparison between the two solutions, i.e. the best reference solution and the graphical solution provided by the individual may be only executed on a graphical basis, or both solutions may be converted into a result or a set of numerical data to be compared with each other.

An additional variant may involve the definition of a different problem from time to time, the graphical solution determined by the individual being converted into a numerical solution and later compared with the computed reference numerical solution, a difference index between the best computed solution and the solution proposed by the individual being computed from said comparison.

Advantageously, the type of problem may be selected in such a manner as to have a set of solutions consisting of a succession of solutions converging towards the best solution.

Preferably, the set of solutions has a discrete number of solutions.

In accordance with an additional variant of the invention, a variable set of solution rules may be defined, i.e. delimiting constraints to limit the graphical and/or computational solution modes.

This allows to finely calibrate the difficulties of the problem to be solved, so that the problem may be adapted to the demographic characteristics of the individual, i.e. to the general culture skills or to the specific knowledge which might affect the result.

Regarding the difference index between the graphical solution proposed by the individual and the computed reference solution, it may consist of an absolute or relative difference value or of a deviation value, such as the standard deviation or any other value indicative of the difference between the two values.

Still according to another characteristic of the invention, several parameters for evaluating the graphical solution proposed by the individual may be provided, such as the problem solving time or any other mathematic-geometric characteristics which might be derived as a parameter of the specific graphical solution.

A variant embodiment of the method of the invention may include several evaluation steps like those described hereinbefore, each of them being based on the comparison between the solution proposed by the individual and a different computed solution, which was obtained by a different best solution computation algorithm and/or a different best solution among the available solutions, the comprehensive evaluation consisting of a combination of said evaluation steps, possibly appropriately weighted.

Advantageously, the proposed problem is such that it has a set of solutions SOL, whose elements Sᵢ consist each of one or more possible combinations of different solving steps pₙ which may be executed in different execution orders.

Particularly, the set of solutions SOL may consist of elements Sᵢ each comprising one of the possible permutations of the steps pₙ within a succession or sequence of steps.

Moreover, still advantageously, the proposed problem is such as to allow a difficulty adjustment, the number of steps and the number of combination permutations of said possible steps being selectable. In this case, the variable number of steps n defines the difficulty of the problem both as a graphical solution and as a mathematical solution.

The solutions Sᵢ consist of a function F of the steps pₙ belonging to the corresponding sequence of the n steps pₙ, said function taking different values depending on the selected permutation order of the n steps pₙ. This function F(pₙ) is selected in such a manner as to be an easily executable mathematical and graphical operation, whereas the difficulty is defined in the increasing number of possible permutations, in a typically exponential function.

According to a further variant, the type of problem proposed is advantageously such that each preceding steps qualitatively and quantitatively affects at least the next step, or even several succeeding steps.

The method of the invention involves the graphical representation of the practical problem on a video screen and the graphical solution of the problem on said screen by graphically performing the single steps in succession. Then, the graphical solution is converted into the corresponding numerical value and compared with the reference solution obtained by mathematical computation.

A correlation table may be determined with the help of calibration tests on sample individuals having known cognitive performances, to interpret the deviation or difference index between the value of the solution given by the individual and that of the computed reference solution.

According to the invention, a typical problem is the so-called Traveling Sales Person Problem.

The Traveling Sales Person Problem consists in defining a list of sites arranged over an area, which sites have different locations, and have to be visited by the Traveling Sales Person, whose role is taken by the individual. The individual has to choose the sequence of the sites to be visited in such a manner as to minimize the total length of the path.

From the graphical point of view, in this case, the method involves the definition of an at least two-dimensional space, wherein the locations are defined by points distributed over this space, whereas the graphical solution consists in drawing the route to minimize the global length thereof, in the form of point connecting segments.

The mathematical description consists in the definition, by an at least two-dimensional reference system, of the different locations, in the form of at least two coordinates for each location, whereas the solution of the sequence of connection segments between individual points is computed on the basis of the mathematical determination of the distance between successive points and corresponds to the sum of the individual distances of successively connected points, according to the sequence of successive points which provides a minimum value of the sum of the connecting segments. In this case, the path minimization solution must be determined by computing all the possible sequences, hence by comparing the obtained path lengths and determining the smallest one.

With reference to this problem, it is apparent how the latter is mathematically trivial, but extremely complex from the computational point of view, even when considering a relatively small number of points, such as 10 or more points. Here a very great number of possible sequences is provided, the number of possible permutations of the individual steps being an exponential function of the total number of steps.

Referring to the general characteristics of the method of the invention, a fixed point distribution pattern may be provided or a set of different point distribution patterns, the best reference solution being known for each pattern.

Alternatively, the solution may be computed from time to time, the point distribution pattern being determined all over again at each method execution.

The distribution pattern may be generated, for instance, by means of a random generator of point coordinates.

To obviate the drawback caused by excessively long computation times, the method of the invention involves that the solution, i.e. the determination of the shortest path, be computed by so-called genetic algorithms, such as those described, for instance in “Reti Neurali Artificiali e Sistemi Sociali”, page 465-486, 21. Genetic Dopping Algorithm, by Massimo Buscema, Edizioni Franco Angeli Milano 1999.

The problem is solved by the user in a purely graphical manner and based on perception and visual estimate, as well as on short-time memory skills and on heuristic bases.

The solution essentially consists in drawing straight lines to connect the individual points of the selected sequence.

The conversion of the graphical solution into path length is trivial per se since, after defining a connection sequence for successive points which are uniquely defined by coordinates in a two-dimensional space, such conversion requires a simple distance or length determination.

Several graphical problem solving rules may be provided, such as:
Each point shall be connected by two half lines
Each point cannot be hit more than once
All points shall be hit.

These different rules or delimiting constraints allow to calibrate problem solving difficulties as desired without changing the number of points.

Alternatively to or in combination with the above, other parameters may be provided for the comparison with the best reference solution, i.e. with the shortest path solution. These parameters may be, alternatively or in combination, the number of crossovers or hits through one point, the solving time, the path segment drawing order, the determination of the areas of polygons defined by drawn segments and by crossovers and/or the determination of the total area of the surface enclosed by the drawn path, as well as comparisons between said two area values or other characteristics of the solution to be parametrized graphically or mathematically.

It is also possible to evaluate one or more of the above parameters with reference to one or more best solutions, which are predefined and/or computed with the help of different algorithms. In this case, the solution is given by a combination of the individual, possibly weighted evaluations.

The above is possible because, for mathematical problems such as the one described above, i.e. the so-called “Traveling Sales Person” problem and for similar problems, several types of computation algorithms exist, even within the family of genetic algorithms. These algorithms may have different performances, for instance times for obtaining the best result but also modes for computing the algorithms, whereby some algorithms may be more appropriate than others for evaluating the geometric characteristics of the solution proposed by the individual.

Based on the above, the method according to the invention consists in:
Defining an at least two-dimensional space according to a predetermined coordinate system;
Defining the number of points to be distributed in said at least two-dimensional space;
Uniquely identifying the position of each of said points distributed over said space with at least two coordinates determined by random generation;
Displaying a graphical representation of said at least two-dimensional space and of the points distributed thereon;
Generating a succession of point connecting lines in a point connection sequence selected in such a manner as to minimize the total length of the sum of the individual segments connecting successive pairs of points of said point connection sequence, only based on visual evaluation;
Determining the sum of the segments connecting successive pairs of points, on a graphical/visual basis, based on the graphically defined point connection sequence;
Comparing the graphically defined total sum of the point connecting segments, with the total sum of the connection segments of a best reference solution, i.e. a point connection sequence through segments, which minimizes the total sum of the point connecting segments, and determining a difference index based on deviation measurement algorithms, such as absolute difference, relative difference and/or standard deviation and/or other algorithms for estimating differences between values.

Said reference solution may be known and precomputed or computed while the graphical solution is provided.

Therefore, the deviation or difference index obtained thereby may be interpreted by comparison with a table which relates difference indexes and performance evaluation, to be obtained, as stated above, from calibration tests.

According to an additional step, a graphical/visual comparison may be also performed between the computed solution and the one which has been graphically/visually determined by an analysis of the congruence of said graphical/visual solution to the graphical representation of the computed solution.

It shall be noted that the specific Traveling Sales Person Problem, or any other similar problem may be also extended to three- or n-dimensional spaces.

In these conditions, besides a highly objective evaluation based on the difference index, an evaluation may be provided of the logic of the route selected by the user to perform his/her task.

From the above description, the advantages obtained by said method are self-evident. In fact, no particular linguistic or technical knowledge is required to carry out the task, but both the type of task and the solving method are compatible with primitive tools, available to any individual.

The linguistic knowledge, required to communicate with the individual are limited to little easily understandable information only required to explain the task to be performed and the possible use of means to draw the selected route.

Regarding task performance, the task may be carried out in a short time and the use of genetic algorithms for computing the route minimization solution allows to drastically reduce the computation time and to choose a sufficient number of points to be successively connected to obtain that the proposed problem is not trivial for persons having a high educational level, for instance as regards geometric knowledge or work experience.

Therefore, the problem is optimal both for its wide understandability by uneducated individuals, and for the possibility to calibrate difficulties in such a manner as to drastically limit the usage possibility or the incidence on the result by individual-based demographic parameters, such as specific knowledge of people having a high educational level, either in general or in specific fields.

The invention also relates to a method for screening and monitoring cognitive disturbances or diseases.

Particularly, the invention relates to an Alzheimer disease early screening and monitoring method.

The provision of an early screening and monitoring method is extremely important. When considering Italian population only, in which over-sixty-five people are more than 20%, 800,000 cases of dementia are estimated, about 500,000 being attributable to Alzheimer disease. In spite of the importance of dementia as a Public Health problem, standardized evaluation approaches are not widely used in medical practice (Brodaty H., Howarth G., Mant A., Kyrrle S. General practice and dementia—A national survey of Australian GPs. Med J Australia 1994;160:10-14).

The possible reasons thereof include: no recognition of standardized evaluation utility, no familiarity with the available tools, but above all, the limits of the commonly used tools (Camicioli R., Wild K. In “Scale di valutazione in neurologia” Centro Scientifico Editore 1998 pag.125). In accordance with the guiding criteria which are generally assumed as valid to assess Alzheimer disease cases (NINCDS/ADRDA) (McKhann G., Drachman D., Folstein M., Katzman R., Price D., Stadlan E. Clinical diagnosis of Alzheimer's disease: report of the NINCDSADRDA work group under the auspices of Department of Health and Human Services task force on Alzheimer's disease. Neurology 1984;34:939-43), dementia must be assessed by a clinical test observing an impairment in two or more cognitive areas, or a single severe, gradually progressive cognitive deficit; a progressive loss of memory and other cognitive functions; no alterations of the conscious state; first occurrence at an age between 40 and 90; lack of systemic or encephalitis diseases which might explain the progressive cognitive decline.

No universally accepted and diagnostically applicable instrumental tests and/or biological markers are available to date. Therefore, it is essential to count on the availability of neuropsychological testing instruments, which are standardized and calibrated on elderly people, to distinguish physiological age-based modifications of cognitive skills from those associated with the starting phases of AD. An appropriate and especially early diagnosis appears to be the only way to allow a timely intervention, targeted on the causes of reversible dementias, and to establish symptomatic treatments allowing to temporally delay the progression of the dementia-based disease.

To this end, a number of neuropsychological tests which are currently available in international literature have been designed, tested and validated. Some of these are short screening tests, fast and easy to execute, others are actually test batteries for evaluating upper cortex functions. One of the screening tests, the most widely used is the Mini Mental State Examination (Folstein M., Folstein S., McHugh P., “Mini-mental state” a practical method for grading the cognitive state of patients for the clinician. J Psychiatric Res 1975;12:189-98), which is composed of 11 easy tasks. Other short instruments are the Short Blessed Orientation Memory Concentration (BOMC) (Katzman R., Brown T., Fuld P., Peck A., Schechter R., Schimmel H. Validation of the short orientation—memory—concentration test of cognitive impairment. Am J Psychiatry 1983;140:734-39), the Short Portable Mental Status Questionnaire (Pfeiffer E. A short portable mental status questionnaire for the assessment of organic brain deficit in elderly patients. J Am Ger Soc 1975;23:433-41), the Mental Status Questionnaire (Kahn R., Goldfarb A., Pollack M., Peck A. Brief objective measures for the determination of mental status in the aged. Am J Psychiatry 1960; (October):326-28), the Information/Orientation Test (Pattie A H, Gilleard C J. Manual of the Clifton Assessment Procedures for the Elderly (CAPE). Kent, England: Hodder & Stoughton, 1979), and the Abbreviate Mental Test Score (Hodkinson H M. Evaluation of a mental test score for assessment of mental impairment in the elderly. Age Ageing 1972;1:233-8). Unfortunately, one of the major problems of the fast administration tests is that they are quite insensitive for early detection of dementia, i.e. do not discriminate a demented elder man from a non demented elder man. This condition has been checked in several studies on well-known tests and the US Agency for Health Case Policy and Research clinical Practice Guideline on recognition and initial assessment of Alzheimer disease and related dementias (US Agency for Health Care Policy and Research clinical Practice Guideline on recognition and initial assessment of Alzheimer disease and related dementias Clinical Practice Guideline N^{o} 19 Silver Springs, MD US Agency for Health Care Policy and Research, 1996) concluded that no evidence exists to recommend a screening test instead of another, and that no available screening test has a high sensitivity index in the diagnosis of slight to moderate dementia.

In addition to the above problem, another problem is to be considered, because serious evaluation errors may derive therefrom. Any cognitive screening test must be interpreted within a context of additional information provided by the patient or by one of its relatives, which may fully or partly explain the results being obtained, e.g. cultural differences, educational level and premorbid skills, which considerably affect patient performance. A number of studies (O'Connor D. W., Pollitt P. A., Hyde J. B., et Al. The reliability and validity of Mini Mental State in a British community survey. J Psychiatr. Res. 1989; 23:87-96, Jorm A. F., Scott R., Henderson A. S., Kay D. W. Educational level differences on the Mini Mental State: the role of test bias. Psychol Med. 1988; 18:727-731, Fillenbaum G. G., Hughes D. C., Heyman A., Gorge L. K., Blazer D. G. Relationship of health and demographic characteristic to Mini Mental State Examination score among community resident. Psychol Med. 1988; 18:719-726) prove that an inverse proportion relation exists between the educational level and the risk of dementia. There are two types of mechanisms which might cause this phenomenon. The Brain Reserve Hypothesis postulates that individuals have a cognitive reserve in which a dementia threshold is situated; that education promotes the development of a more efficient brain activity, probably through the formation of more numerous or “competent” synapses; and that the occurrence of dementia is delayed in more educated patients, thanks to their greater cognitive resources. Conversely, the Brain-battering Hypothesis (Del Ser T., Hachinski V., Munoz D. G. An autopsy-verified study of the effect of education on degenerative dementia. Brain 1999; 122, 2309-2319) postulates that the apparent effect of education results from its association with the socioeconomic condition. In fact, the socioeconomic status is the main determining factor of exposure to toxic industrial and non-industrial substances, as well as of habits, such as drinking and smoking, of diet and of medical treatment access. Each of these factors may alter the Alzheimer disease risk (Munoz D. G., Ganapathy M. D., Eliasziw M., Hachinski V. Educational Attainment and Socioeconomic Status of Patients with Autopsy-Confirmed Alzheimer Disease. Arch Neurol. 2000; 57:85-89).

In order to obviate the low-sensitivity and specificity problems of short instruments, test batteries have been developed which investigate more deeply into the various cognitive skills; some of these sets are based on existing neuropsychologic tasks (Eslinger P., Damasco A., Bentos A. The Iowa screening battery for mental decline. Iowa City:University of Iowa Press, 1984). These neuropsychological batteries which fully and systematically explore the main upper cortex functions are for instance M.O.D.A., the Alzheimer Disease Assessment Scale (ADAS) (Rosen W., Mohs R., Davis K. A New Rating Scale for Alzheimer disease. Am J Psychiatry 1984;141:1356-64), C.A.M.C.O.G. of C.A.M.D.E.X. (Roth M., Tym E., Mountjoy C.Q. et Al. CAMDEX. A standardised instrument for the diagnosis of mental disorders in the elderly with special reference for the elderly detection of dementia. British Journal of Psychiatry 1986; 149: 698-709), A.G.E.C.A.T. and inside it Geriatric Mental State Examination (Copeland J. R. M., Keller M. G., Keller J. M., et Al. A semistructured clinical interview for the assessment of diagnosis and mental state in the elderly: The Geriatric Mental State Schedule. 1. Development and reliability Psychological Medicine 1976; 6: 439-449) These instruments potentially allow an earlier identification of dementia, but this affects the administration rapidity. For this reason they are adequate especially to specially investigate the residual skills and possibly to establish a rehabilitation treatment. Moreover, since they can better evaluate the alteration of cognitive skills, they are suitable to test the effectiveness of anticholinesteratic drugs.

Therefore, the invention has the object to design an Alzheimer disease early screening and monitoring method which might obviate the drawbacks of currently known methods.

This method is based on two assumptions. The former is the assumption that organization and planning skills, typically associated to problem solving tasks and characterizing the executive function, is a very sensitive indicator of an early phase of the Alzheimer disease (Elias W. J., Treland J. E. Executive Function and Cognitive Rehabilitation. Cognitive Rehabilitation in old Age, New York Oxford University Press 2000). The latter is the assumption that performance against these tasks is significantly different depending on the seriousness of the disease, starting to a very slight phase (minimal dementia) to a moderate phase.

Another object of the invention consists in designing an Alzheimer disease early screening and monitoring method, which provides the proposal of a test task, which may be administered even to individuals having serious linguistic deficits, or to foreign patients, as it includes no verbal interaction, except as regards the explanation of the task, unlike all the other tests available from the literature.

Yet another object of the invention consists in that the proposed task is not affected by the educational level, by premorbid skills, by culture and by age.

A further object is to design an Alzheimer disease early screening and monitoring test, which also shares some typical characteristics of culturally free tests, according to Jensen classification (Jensen A. R. Bias in mental testing, New York Free Press 1980), and particularly meets the following criteria: power test, only figurative material, non-verbal contents, educationally-unrelated skills, new problem solving, initial test items, responses given on the test, oral or mimed instructions.

Yet a further object of the method according to the present invention consists in designing an Alzheimer disease early screening and monitoring method, in which the proposed test task does not require the implementation of particular strategies and the use of knowledge in abstract situations, far from everyday life and, finally, in which the test can be completed in a short time.

The method according to the invention consists in the performance of a test, whose task is a practical problem and may be exactly represented both graphically and mathematically and solved both graphically and computationally, which task has a set of solutions with a number of elements greater than one, one element being the best possible solution, and wherein the individual provides a graphical solution and said graphical solution is compared with a best reference solution, at least one difference index between said best reference solution and said solution determined by the individual being computed from said comparison.

Particularly, the test comprises any combination or sub-combination of the characteristics of the method for evaluating the cognitive performance of an individual as described above, and particularly consists in the solution of the so-called Traveling Sales Person problem, according to one or any more combinations or sub-combinations of the characteristics described above with reference to the general method for evaluating the cognitive performance of an individual.

The Alzheimer disease early screening and monitoring method according to the invention may be also provided in combination with one or more of the additional known tests listed above.

The method according to the invention has been tested on populations of individuals in a healthy state and suffering from different levels of Alzheimer disease or by elderly dementia. The resulting data proved that the performance against the Traveling Sales Person Problem seems to be independent from the visuospatial memory and is not related to the Trail Making (A form), probably because they investigate two different types of executive functions. The Trail Making appears as a form of guided planning based on the knowledge of numbers, hence it evaluates the executive functions within the crystallized intelligence, whereas the Traveling Sales Person problem appears as a form of free planning, i.e. within fluid intelligence. According to Jensen criteria, the Traveling Sales Person problem appears to be independent from demographic variables, which have traditionally proved to affect the performance against psychometric tests, such as age, sex, educational level. The Traveling Sales Person Problem discriminates with a high degree of accuracy, ill subjects from healthy subjects. Therefore, the study allowed to find a novel screening instrument, which might be more sensitive than the previous ones, while maintaining the basic characteristics of short psychometric tasks. Furthermore, the performance against the Traveling Sales Person problem with a limited number of points (about 30) appears to be strictly related to the cognitive state of the patient suffering from Alzheimer disease and remains easy to administer even in the moderate stage of the disease. The Traveling Sales Person Problem may be further used to monitor the course of the disease and to ascertain the effectiveness of drug and non-drug interventions.

As regards both the general cognitive performance evaluation method and the use thereof as a mass diagnostic instrument for Alzheimer disease, the selection of the task as a Traveling Sales Person Problem is not the only possible one.

Alternatives thereto may include, for instance, the three colors problem, in which the cells of a grid must be colored with different colors from directly adjacent cells, on every side, i.e. right, left, above and below. The first column is to the right of the last column and the top row is below the bottom row and vice versa; The particular problem with a grid size of 5 by 5 cells allows to provide a solution with two colors exactly, without considering the last set of constraints. An example of the two-color solution is the checker board. When said constraints are considered, then the solution requires three colors. There are at least 847,288,609,443 possible colorings and about 1,000 solutions which meet the constraints.

Obviously this problem includes aspects that may be advantageous or not as compared with the Traveling Sales Person Problem. Nevertheless, this problem proves that problems may be provided as an alternative to the Traveling Sales Person Problem.

The method for evaluating the cognitive performance of an individual may be also used in business fields.

The invention also relates to an apparatus for evaluating the cognitive performances of an individual, which apparatus comprises:
A screen displaying an at least two-dimensional area and points distributed over said area;
Means for drawing segments to connect pairs of said points by means of connection lines to be displayed on said screen;
An electronic processing unit with a memory containing the algorithms for generating the at least two-dimensional space and for generating the coordinates of the different locations, the algorithms for generating a graphical representation of the at least two-dimensional area and of the individual points, the algorithms for drawing the point connecting segments and for displaying said connecting segments on the screen, the algorithms for determining the total length of the drawn segments and the algorithms for pure mathematical computation of all the point connecting segments, in a connection sequence which minimizes the total length of said segments, as well as a possible algorithm for alternately or adjacently displaying all the point connecting segments, as obtained from the algorithm for computing the reference solution, and as set by the individual in the graphical/visual solving attempt.

Furthermore, said apparatus may comprise means for overlapped display of all the drawn successive point connecting segments and all the computed successive point connecting segments, the segments from the two different sets, i.e. the drawn set and the computed set being highlighted in different manners, e.g. in different colors, and the congruent connecting segments from the two solutions being highlighted, for instance with two-color, double or three color segments.

According to an additional characteristic, the apparatus may also include algorithms for determining a quantitative differentiation index between the drawn and the computed sets of segments and/or between corresponding total lengths.

Here, storage of interpretation criteria may be also provided, based on empirically or experimentally established data tables, as well as means for comparing the differentiation index with said interpretation tables.

Advantageously, the apparatus may include a memory or a memory section designed for collecting and storing the sets of segments drawn by a uniquely identified individual when graphically solving different problems with different number distributions, there being provided algorithms for determining an average differentiation index based on the individual differentiation indexes between the drawn set and the computed set, as determined during the performance of the different successive tests.

There may be also provided data for characterizing the typical data of the individual which have a potential influence on the test execution and may used to define parameters for weighting the differentiation indexes to account for any particular specific skills of the individual in extreme conditions.

These parameters or specific skills and the relevant effects on the differentiation indexes may be defined on an experimental basis and statistically attributed to the individual depending on parameters such as age, job type, duration of employment in that specific job, cultural or educational level or on the basis of other demographic parameters or of combinations thereof.

Moreover, said parameters may be used to define task difficulty parameters, for instance and essentially to define the number of points to be determined.

The above means may be of the conventional type, consisting of a simple computer or of a dedicated computer similar to a game pad, with the minimum of control interfaces and inputs required for task execution, to minimize any inhibiting effect generated by a traditional computer in little educated users.

In this case, memories are conventional computer memories and the various functions are algorithm executing programs, whereas the screen is the computer monitor, in both cases of traditional computers and of game pads.

The apparatus of the invention in the above embodiment is also highly advantageous in view of the integration thereof in a network for collection, archive, and consultation of data on individuals. Further improvements of the invention will form the subject of the subclaims.

The characteristics of the invention and the advantages deriving therefrom will appear more clearly from the description of a non-limiting embodiment, as shown in the annexed drawings, in which:

FIGS. 1 to 24 show the different solutions to an example of the so-called Traveling Sales Person Problem having a number of steps n=4.

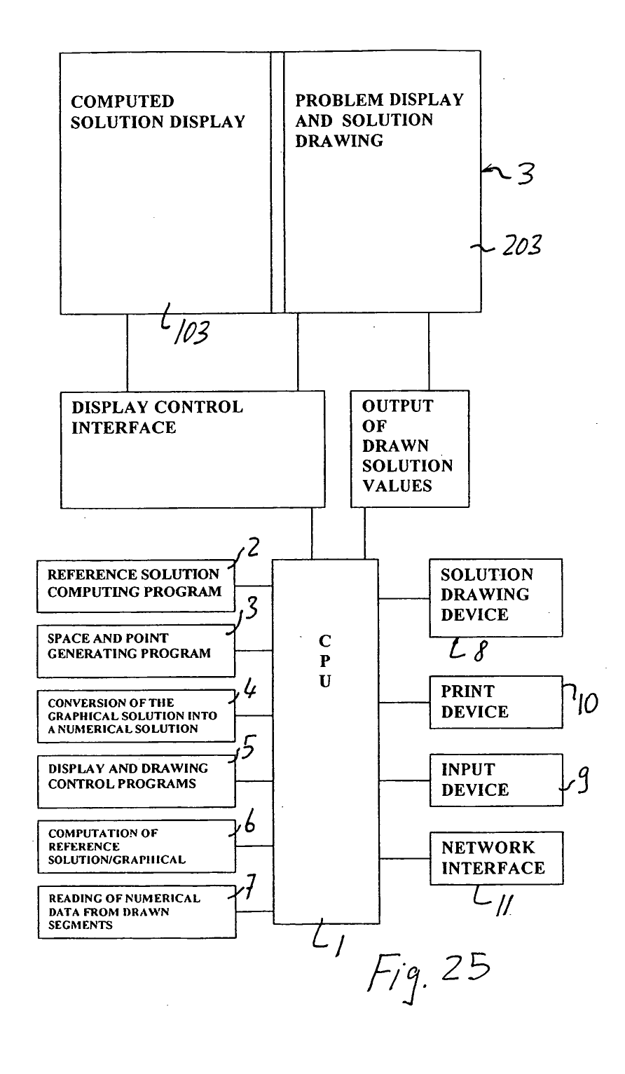

FIG. 25 shows the block diagram of an apparatus for implementing the method according to the invention.

FIGS. 1 to 24 show a two-dimensional space defined by x and y coordinates and in which space four points P1, P2, P3, P4 are entered, having coordinates (Xᵣ, Yₜ).

The set of solutions SOL includes the solutions Sᵢ, each being the sum of the lengths of the connecting segments Rx, which connect pairs of points in a predetermines sequence of the 24 possible sequences.

The best solution is the solution Sᵢ, for which the sum of the segments Rₓ has the lowest absolute value.

As easily determined, there are 24 possible solutions Sᵢ which correspond to the number of possible permutations of the point P connection order. The various lengths of the individual lines Rₓ may be trivially computed based on the pairs of coordinates (Xᵣ, Yₜ) which define the position of the points P in the two-dimensional space X-Y. However, this computation is not fast, since the possible permutations of the point P connecting sequences have 24 elements with four points only.

The chart clearly shows how, on a merely heuristic and experience basis, a solution may be graphically generated which may be even the best when four points are provided, but may be anyway considerably similar to the best solution as compared with the other possible solutions. In fact, with reference to an averagely skilled individual, the illogical or irrational connection sequences are automatically excluded, as well as the connection sequences which, based on a minimum reasoning and experience may be assumed as non advantageous for the purposes of task solving. Considering, for instance, the point P₁ as the starting and ending point of the traveling salesman, then it is easy to see how, on a purely visual and logical basis, many solutions are immediately removed as requiring double routes.

In fact, the solutions having P₁ as a route starting and ending point are to be considered preferred solutions which do not require path duplications. These solutions are solutions S1 to S8 of FIGS. 1 to 8, S15 of FIG. 15, S17 of FIG. 17, S21 of FIG. 21 and S23 of FIG. 23.

The selection of the best solution amongst the above mentioned solutions may not be trivial, whereby these solutions may be considered as parts of a subset, in which the deviation of the graphical solution from the reference computed solution is relatively small as compared with other possible solutions.

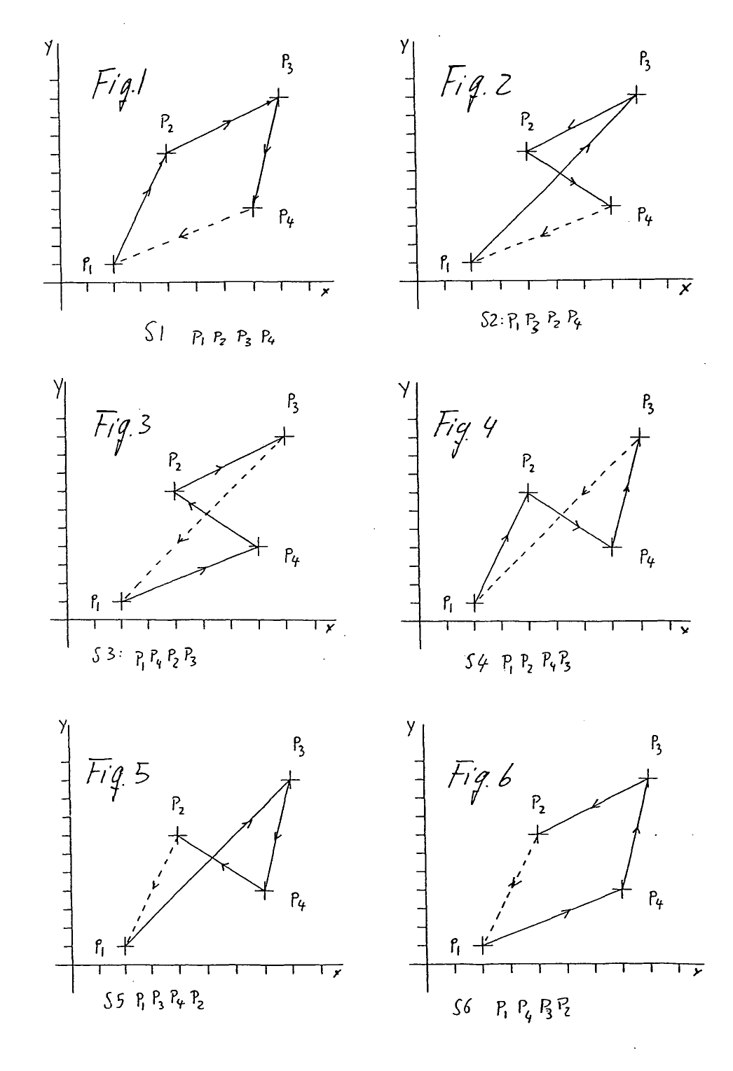

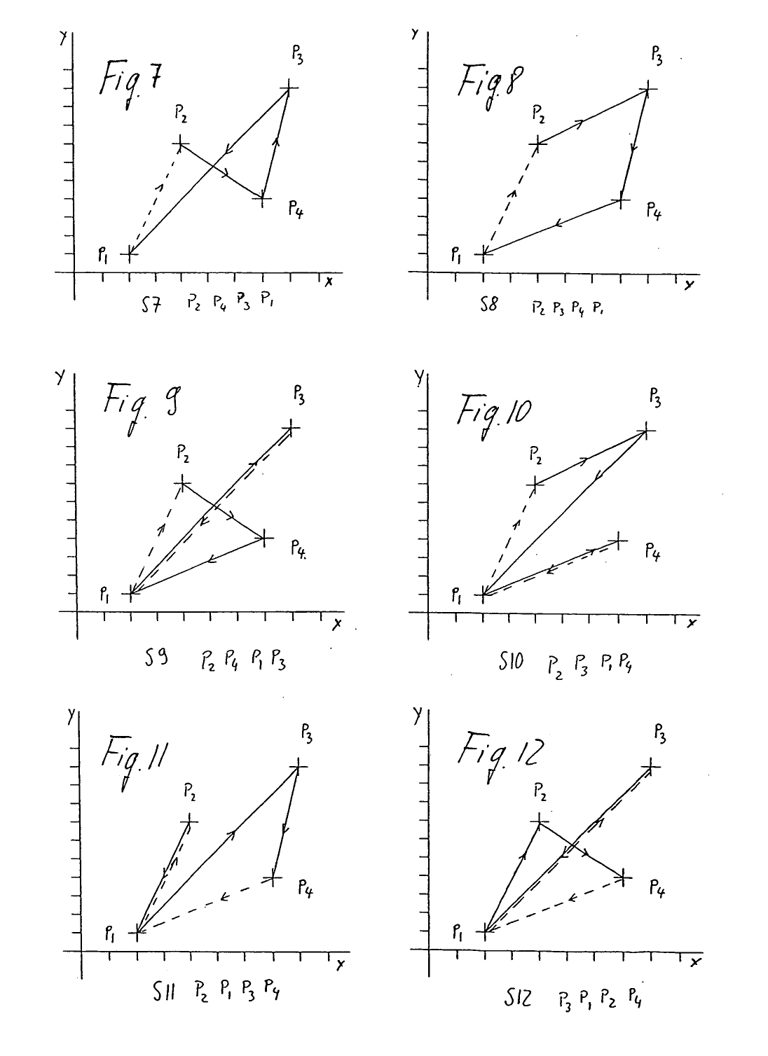

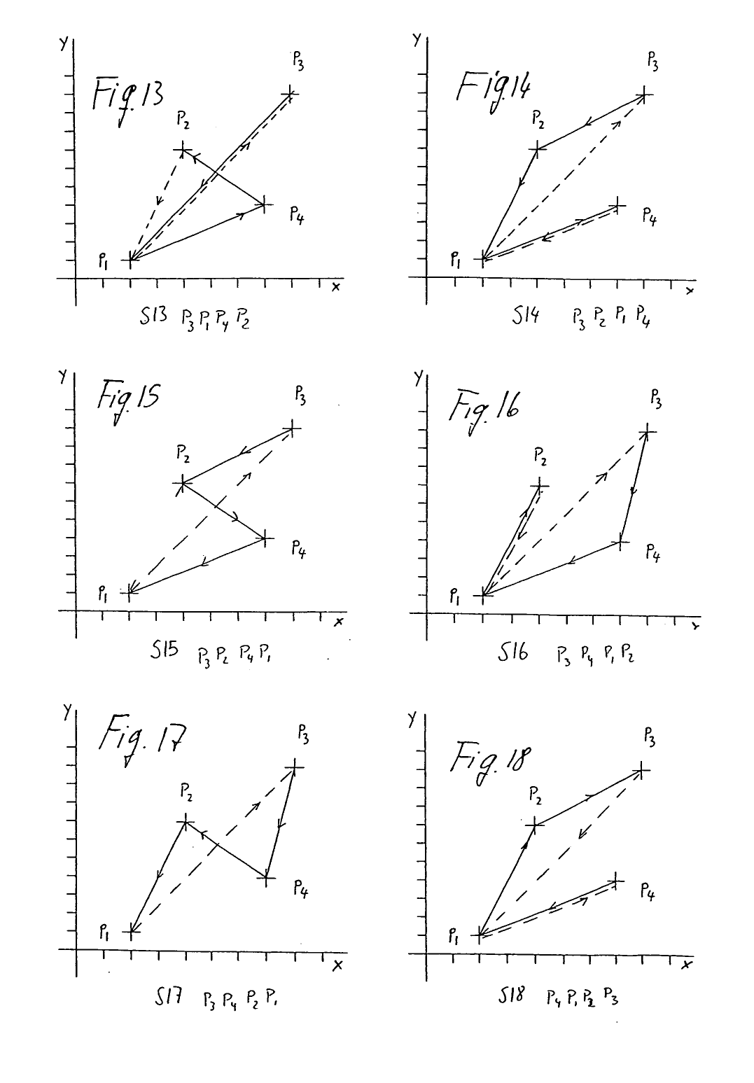

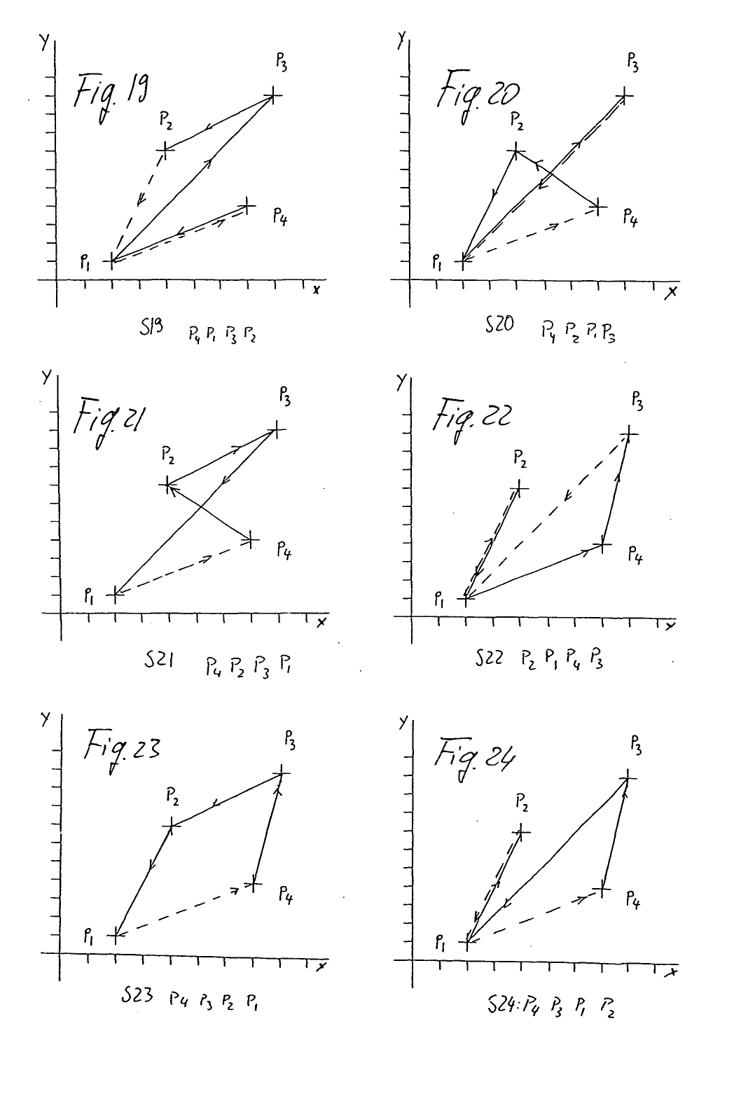

Moreover, in the subset of solutions having P₁ as a starting and ending point, some solutions are relatively illogical and may be further used to evaluate the proposed solution, e.g. based in the graphical/visual comparison with the best solution. (See for instance the solution of FIG. 1 and that of FIG. 2).

The complexity, i.e. the number of necessary combinations in the mathematical computation of the set of solutions increases exponentially with the increase of the points pₙ selected to define the problem. With ten points, the mathematical and graphical solutions are already far from being trivial, and the time to compute the various possible permutations for point connection sequences increases considerably. Moreover, the effect on the solution of not only cognitive but even intellectual skills, and of knowledge, e.g. geometric knowledge is also limited. Nevertheless, from the graphical point of view, it is still rather easy to identify a graphical solution which, while not being the best one, is close, within predetermined deviations, to the best one.

When 30 points are provided, the indication of the best solution becomes rather difficult, even graphically, especially when random best solution identification factors are filtered off or drastically reduced, as the set of solutions statistically has a huge number of elements, whereby the random identification of the best solution becomes statistically improbable. Moreover, with 30 points being provided, the effect of the individual's cultural and educational level on the solution is also minimized, due to the fact that the control of the various geometric configurations which might provide indications on the shortest path selection is extremely complicated. Moreover, it shall be noted that, with 30 points, the consequences on the route to be drawn are no longer easily foreseeable without a deeper analysis of the problem and without the help of at least a written list of options, to evaluate the consequences of the selections made on the path to be drawn.

Even from the computational point of view, the problem is no longer trivial, because, while the function to determine the successive point connecting segment lengths is computationally trivial, the definition of all possible permutations and the execution of said function for each connection segment of each solution element becomes complex and especially not performable in acceptable times, by using simple algorithms.

In this case, the invention provides two possibilities:
In a first case, point distribution is generated on the basis of a single fixed pattern or of a pattern selected among a plurality of fixed patterns whereof the best solutions are known and stored.

In a second case, point distribution is generated from time to time, e.g. on the basis of a random point generator and possibly in combination with means for checking that the different points have certain mutual relations, defined by selection criteria, e.g. requiring that the points do not fall all along a certain line, or too close to each other or in overlapping positions. The selection or rejection criteria for the generated points may even allow a limited number of points not to meet the selection criteria. In this latter case, the problem is to be solved from time to time, wherefore the help of the so-called genetic algorithms appears to be useful.

Regarding the solution, other constraints may be established in addition to the simple connection of successive pairs of points by segments, to form a path passing across all the points, and having a minimum total length. For instance, it is possible to limit the number of segments crossing the same point or prevent any segment crossover or limit the number thereof even out of the path. These additional constraints allow to considerably reduce the number of possible solutions since, referring to the illustrated embodiment, several solutions are removed which are possible a priori but apparently illogical and impractical.

Regarding the illustrated embodiment, it is limited to four points to simplify the explanation of the method, while it shall be understood that four points will not be sufficient for the method to have a significant relevance.

With particular reference to the steps of the method, the latter consists in converting the drawn graphical solution into a numerical solution, i.e. in this case in computing the sum of the lengths of the point pₙ connecting segments according to a sequence indicated graphically by the individual and based upon the known coordinates of the points pₙ.

At the same time as the graphical solution, the best solution is also processed, by mathematical computation. With the above four points, said computation is trivial, there being only provided 24 possible permutations, some of them being identical. When a greater number of points is provided, i.e. ten or thirty points, the solution shall be processed based on said genetic algorithms.

Hence, two absolute values are obtained, for the sums of the segments for connecting the graphically selected sequence of points on the one hand and of the computationally defined point sequence on the other, the latter minimizing the absolute value of said sum. Then said two values are compared to determine a deviation index between the graphical solution and the computed solution. This index is determined according to mathematical-statistical criteria, such as simple difference, relative difference, standard deviation, and other functions for determining the deviations between data. As a result, the method of the invention provides a numerical value which is defined on strict mathematical bases and up to this step evaluation is totally objective. The evaluation result may be further interpreted against a scale for attributing, on an experimental or statistical basis, different interpretative evaluations of cognitive performances of the individual. The relation of the value obtained as a result of the method to the interpretative evaluation scale may be also obtained by introducing possible correction parameters depending on the demographic conditions of the individual and on test performance conditions. This may be useful to account for extreme cases, in which the individual has objective difficulties in performing the test, e.g. little or no familiarity with the physical means required to draw the result.

The evaluation of the proposed graphical solution may also account for other different parameters, such as the time required to provide a solution, the occurrence of route discontinuities and even the choice of solutions which are too close to the reference solution.

Besides a personal skill test, or for instance a test for evaluating the skills of individuals for proper employment in a work situation, the method of the invention may be also a help or indication instrument to detect pathological cognitive disturbances. In this case, the instrument provided by the method of the invention is not a diagnostic instrument but a simple indicator of the potential presence of cognitive disturbances which may be possibly related to pathological conditions, yet to be diagnosticated by real appropriate diagnostic methods.

Referring to another improvement, the method of the invention includes a preliminary step which consists in solving a simplified form of the problem, i.e. with a reduced number of points pₙ, e.g. the preliminary step requires the method to be implemented with a ten point problem and later the method is implemented with a test problem based on a greater number of points, e.g. 30 points.

This preliminary step involving the execution of a simplified problem allows the user to get familiar with the apparatus and with the problem, to limit the occurrence of false solutions caused by a lack of familiarity with the apparatus or by misunderstandings about the task to be performed. In this situation, a deviation threshold may be defined between the drawn solution and the computed reference solution whereby, if the performance of the task in its simplified form, e.g. with ten points, provides deviation values below said threshold, the method passes automatically and immediately to the more complex problem, e.g. with 30 points.

If the first simplified execution results in excessively high deviations, then there may be provided an automatic repetition of said simplified execution for a predetermined number of times. If deviation remains too high even after the execution is repeated a predetermined number of times, an intervention of the personnel in charge is required, because a potential misunderstanding or error situation is detected.

There may be multiple, even traditional apparatuses for implementing the method of the invention, such as a simple paper sheet on which the points are drawn, for the individual to make connections to create the best selected route. In this case, data may be visually read and entered in a computer which contains the necessary programs to convert the graphical/visual solution into a numerical solution and to compute the best solution, i.e. the solution which minimizes the total route distance.

FIG. 25 shows a block diagram of a preferred apparatus for implementing the method and particularly with reference to the Traveling Sales Person Problem.

The apparatus includes a processing unit, typically a CPU or a personal computer 1 wherewith several memories or a single memory divided into sections are connected. Memories or memory sections 2 to 7 contain the program for generating the two-dimensional space and for determining the points pₙ, the program for computing the solution on a mathematical basis, typically a so-called genetic algorithm, a program for displaying the two-dimensional space and the points on a monitor or a display device, a program for controlling the means for entering the point pₙ connecting segments, a program for reading and displaying the drawn point pₙ connecting segments.

Hence, the apparatus includes display means such as a monitor 3 or the like and means 8 for entering segment drawing controls. Moreover, the apparatus includes means 9 for entering further data, parameters or controls, such as the number of points to be displayed. Additional interfaces may be also provided, such as a printer 10, a network adapter 11 for connection to a central data storage system, means for data storage on any type of storage media.

The above apparatus may consist of a traditional personal computer, wherein the input means are a traditional mouse or the like and the display means is a traditional monitor. Instead of a traditional mouse, a pen-like mouse may be provided. The pen may be also associated with a so-called graphical table.

Regarding simplicity, especially for poorly educated users, a so-called touch screen device may be used as a display and input device, i.e. a display monitor whose outer surface is sensitive and acts as an input device, operating either by direct touch or by the touch of a tool like a pen or the like.

The advantage of touch screens is considerable because these means obviate the difficulties a user may have in test execution, when he/she is not familiar with typical computer input means or the like. In this case, for instance, drawing operations are performed according to indications by touching the successive point to be connected to a predetermined starting point. Hence, the successive point connecting segment is automatically drawn by the computer, which identifies from the coordinates the two points to be connected, that have been selected by touching the image thereof.

According to a variant, the display screen 3 may be divided into two parts 103, 203, one of which is used for drawing the route selected by the individual, whereas the other part is used to display the step selected through mathematical computation by the computer or through the computation algorithms loaded therein.

At the end of the task the two routes will be displayed in tiled position on the screen, i.e. the one selected by the individual on a graphical/visual basis and the one computed by the computer.

Moreover, the computer will convert the graphical/visual solution processed by the user into numerical data which are used to compare said graphical/visual solution with the computed one, therefore to determine an approximate value of the deviation between the two data.

Regarding the apparatus for implementing the method, it may be made in any manner and, as an alternative to the embodiment described above, which essentially involves typical personal computer means, it may be composed of means specially designed for implementing the method, and particularly with reference to the Traveling Sales Person problem.

Particularly, as regards the Alzheimer disease early screening and monitoring method, a test as described in the following embodiment is provided.

The “Traveling Sales Person problem” is an application for PC and Macintosh. The computer monitor must be at least 14 inches wide to allow an optimal perception of stimuli by the individual. Once the program is loaded and started, the screen shows two identical surfaces, one at the right side and one at the left side of the screen, each of 12 cm×14 cm. Both represent the field in which stimuli are identically distributed, which stimuli consist of points having a diameter of 2 mm. The test proposes a task wherein the individual is invited to draw the path, at the right side of the screen, to lead him/her from one point to another and to more other points, until he returns to the starting point. The route is drawn by the tester following the indications of the individual. The difficulty lies in that the route must be as short as possible. Therefore, the independent variable being measured is the distance, in km, run by the individual. If the right part of the screen is the part on which the individual draws the route, the left part is the surface on which the computer, by using a genetic algorithm draws the ideal route, i.e. the one which runs the shortest possible distance. Two tests are provided, a running-in test and the real test, the former being executed with 10 points, the latter with 30 points. The ideal distance is of 287,4203 km for the 10 point test and of 423,7406 km for the 30 point test. The result is recorded in a fast and reliable manner, no paper document being required, but only a Powerpoint presentation in which the routes obtained by the individual and by the computer are “pasted”, and the deviation between the two is displayed.

An example of the administering procedure involves that individuals are allowed to sit in a room which may be darkened. The doctor or other personnel, after introducing themselves and engaging the individual in a brief introducing conversation, show him/her the computer and ensure the screen inclination and the room lighting allow an optimal vision of stimuli. The instructions provided to the patient are as follows: “Start from any point on the screen and draw a route to connect all these points until you get back to your starting point. The route should be as short as possible. You will have no time limit. You will also be allowed to correct your route by moving backwards and restarting whenever you wish, until you will find the route that, in your opinion, is the shortest possible route to connect all the points.”

Once the understanding of the problem by the individual is verified, the first task is introduced, as a “run in”. The “run in” has a reduced number of stimuli, i.e. points, e.g. 10. At the end of the task, the performance of the individual is positively reinforced and the individual is shown the ideal route, processed by the computer. The test result, i.e. the route length, is measured in km and often, especially in the most serious cases and in the 30 stimuli test, the deviation between computer performance and individual's performance is very high. In these cases, it is more useful to ignore the numerical comparison and to simply show the different route run, insisting on the purpose of drawing a short route. After a brief pause, which may be used by the doctor or other personnel to record performance, the real 30-stimuli, i.e. 30-point task starts. It is essential to repeat the instructions for the user, and to specify that the new task includes no longer 10, but 30 stimuli. The result is recorded once again at the end of the performance, after allowing the individual to compare the obtained result with the computer result, provided the individual is interested.

With reference to a particular condition of test execution according to the diagnostic method as proposed herein, it shall be noted that several solutions may be provided which are exaggeratedly close to the best possible solution being used as a reference. In this case, it must be considered that the individual who performed the test may suffer from psychiatric diseases such as autism, or the like, which involve particular skills in solving this type of problems, whereby the test might be used not only to detect cognitive disturbances resulting in wrong or illogical solutions of the proposed problem, but also to solutions which are surprisingly close to, or have a minimum deviation with respect to the best reference solution. This does not mean a priori that the individual suffers from these diseases, since from the statistic point of view there is a non-zero probability that an individual guesses the best possible solution, which may be even better than the one computed by a genetic algorithm. Nevertheless, this probability is really low and the simple repetition of the test generally results in completely different solutions. When the performance repeatedly results in high level matches between the proposed solution and the best computed or known solution, then the result provides an indication of a particular condition of the individual who performed the test, which certainly requires further investigation.

1. A method for evaluating the cognitive performance of an individual by qualitative/quantitative analysis of the performance of a task, characterized in that:
the task is a practical problem which may be exactly represented both graphically and mathematically and solved both graphically and computationally;
the task has a set of solutions with a number of elements greater than one, one element being the best possible solution;
and wherein the individual provides a graphical solution;
said graphical solution is compared with a known best reference solution and at least one difference index is determined between said best reference solution and said solution proposed by the individual from said comparison.

2. The method of claim 1, characterized in that the task is always the same and the best reference solution is precomputed.

3. The method of claim 1, characterized in that it includes two, three or more different tasks, whose respective best reference solutions are precomputed or known.

4. The method of claims claim 1, characterized in that the comparison between the best reference solution and the graphical solution of the individual may be only performed on a graphical basis, or both solutions may be converted into a numerical result or a set of numerical data to be compared with each other.

5. The method of claim 1, characterized in that a different problem is defined from time to time, the graphical solution determined by the individual being converted into a numerical solution and later compared with the computed reference numerical solution, a difference index between the best computed solution and the solution proposed by the individual being computed from said comparison.

6. The method of claim 5, characterized in that the different tasks are characterized by a certain number of variables which are randomly generated every time.

7. The method of claim 1, characterized in that the problem is such that it has a set of solutions, consisting of a plurality of solutions, at least one of which is the best or correct solution of the problem.

8. The method of claim 7, characterized in that the set of solutions has a discrete and finite number of solutions.

9. A The method of claim 1, characterized in that the difference index between the solution proposed by the individual on a graphical basis and the computed reference solution is a function for determining the deviation between two values, among which particularly the absolute difference or relative difference values, or the deviation value, such as the standard deviation.

10. The method of claim 1, characterized in that a set of rules is provided, i.e. delimiting constraints, to provide the graphical and/or computational solution, which may be applied to a different extent and in different combinations.

11. The method of claim 1, characterized in that each solution has more variables or solution parameters, one or more of which parameters or variables may be compared with the corresponding ones of the best solution or with other reference parameters for determining cognitive performances.

12. The method of claim 1, characterized in that the proposed problem is such that it has a set of solutions, whose elements consist each of one or more possible combinations of different solving steps pₙ which may be executed in different execution orders.

13. The method of claim 12, characterized in that the set of solutions may consist of solution elements each comprising one of the possible permutations of the steps pₙ within a succession or sequence of steps.

14. The method of claim 1, characterized in that the proposed problem has at least one difficulty adjusting or setting variable.

15. (canceled)

16. The method of claim 14, characterized in that said difficulty setting parameter comprises the number of steps, hence the number of permutations of said possible steps which is equivalent to the number of solution elements of the set of possible solutions, there being provided at least one best or correct solution element and/or the definition of additional solution determining rules, i.e. the determination of delimitation constraints.

17. The method of claim 1, characterized in that the solution elements consist of a function of the steps pₙ or of an operator on said steps, which takes different values depending on the sequence which orders the execution of the n steps pₙ.

18. The method of claim 17, characterized in that this function is selected in such a manner as to be an easily executable mathematical and graphical operation, whereas the difficulty is defined in the increasing number of possible permutations of executions of steps pₙ.

19. The method of claim 1, characterized in that the problem proposed is of such a type that each preceding steps qualitatively and quantitatively affects at least the next step, and/or even several succeeding steps.

20. The method of claim 1, characterized in that it involves the performance of tests for calibrating a scale or a table to interpret the deviation or difference index between the value of the solution given by the individual and that of the computed reference solution.

21. The method of claim 1, characterized in that it includes the performance of at least a first step and at least a second step, the first step being a familiarization step in which the problem is introduced in a graphical/visual manner, the problem is solved by a graphical/visual instrument, a reference solution is simultaneously computed with a mathematical method; the graphical/visual solution is converted into a numerical solution and the graphical/visual solution and the reference solution are compared, with a deviation index being determined between the two, based on the simplified problem, and an evaluation step, in which said operations are performed on the basis of a problem set on a higher difficulty level.

22. The of claim 21, characterized in that a reduced number of steps is provided in the familiarization step, as compared with the evaluation step.

23. The method of claim 21, characterized in that a deviation threshold is established, and the familiarization step is repeated as long as the deviation determined in said familiarization step is not below said threshold or for a predetermined number of times before passing to the evaluation step.

24. The method of claim 1, characterized in that the problem is the so-called Traveling Sales Person Problem, in which a list of sites, distributed over an area, is defined, which sites have different locations and must be visited in succession, along such a route, i.e. such a sequence or succession of location hits that the total length of the route is minimized.

25. The method of claim 24, characterized in that an at least two-dimensional space is defined, wherein the locations are defined by points distributed over this space, whereas the graphical solution consists in drawing the route to minimize the global length thereof, in the form of point connecting segments.

26. The method of claim 24, characterized in that the mathematical description consists in the definition, by an at least two-dimensional reference system, of the different locations, in the form of at least two coordinates for each location, whereas the solution of the sequence of connection segments between individual points is computed on the basis of the numerical determination of the sum of the lengths of successive point connecting segments, according to the point connecting sequence which provides a minimum value of said sum of the connecting segments.

27. The method of claim 26, characterized in that, in order to compute the sum of the point connecting segments according to a point sequence which minimizes this sum, so-called genetic algorithms are used.

28. The method of claim 24, characterized in that the graphical/visual solution of the problem in a purely graphical mode consists in drawing point connecting segments in a selected connection sequence.

29. A The method of claim 24, characterized in that the conversion of the graphical solution into a numerical solution is obtained by computing the length of the connection sequence, which is selected when the point connecting segments are drawn.

30. The method of claim 24, characterized in that it has at least one, two or more different fixed point distribution patterns, said points representing the sites to be visited and the corresponding best solution is provided for each point distribution pattern.

31. The method of claim 24, characterized in that points, which represent the locations to be visited, are determined on the basis of random number generating algorithms, wherewith at least two coordinates are defined for each point and the best reference solution is determined from time to time.

32. The method of claim 24, characterized in that the parameters for comparing the user-supplied graphical solution with the known solution, are the total length of the two routes and/or the number of crossovers and/or the connecting segments passing through each point and/or the presence of route discontinuities and/or the execution time.

33. The method of claim 24, characterized in that it includes the following steps:
defining an at least two-dimensional space according to a predetermined coordinate system;
defining the number of points to be distributed in said at least two dimensional space;
uniquely identifying the position of each of said points distributed over said space with at least two coordinates determined by random generation;
displaying a graphical representation of said at least two-dimensional space and of the points distributed thereon;
generating a succession of point connecting segments in a point connection sequence selected in such a manner as to minimize the total length of the sum of the individual segments connecting successive pairs of points of said point connection sequence, only based on visual evaluation;
determining the sum of the segments connecting successive pairs of points, on a graphical/visual basis, based on the graphically defined point connection sequence;
comparing the graphically defined total sum of the point connecting segments, with the total sum of the connection segments of a best reference solution, i.e. a point connection sequence through segments, which minimizes the total sum of the point connecting segments, and determining a difference index based on deviation measurement algorithms, such as absolute difference, relative difference and/or standard deviation and/or other algorithms for estimating differences between values.
said reference solution being known and precomputed or computed while the graphical solution is provided.

34. The method of claim 24, characterized in that the deviation or difference index between the graphical/visual solution and the computed reference solution is interpreted by comparison with an experimentally established calibration table or scale.

35. The method of claim 1, characterized in that it provides that the reference solution be graphically displayed.

36. The method of claim 1, characterized in that it includes the graphical/visual comparison of the reference solution with the one determined in a graphical/visual manner by overlapped and/or tiled display of the two solutions.

37. The method of claim 36, characterized in that it provides that the coincident connection segments in the two solutions be highlighted with respect to non-coincident connection segments.

38. The method of claim 36, characterized in that it provides that the two solutions be displayed in different colors for non-coincident segments, whereas coincident segments are displayed in the two colors selected for displaying the two solutions, or in a third color.

39. The method of claim 24, characterized in that it includes a familiarization step, providing a reduced number of points to be connected, as compared with the number of points provided in the evaluation step.

40. The method of claim 1, characterized in that it includes the determination of factors for weighting the graphical/visual solution and/or for decreasing/increasing difficulty to correct or adapt to specific extreme conditions of individual-related demographic parameters.

41. A method for early screening and monitoring of Alzheimer disease, characterized in that it has characteristics as recited in claim 1.

42. A method for business applications, characterized in that it has one or more characteristics as recited in claim 1.

43. A method for evaluating the cognitive performance of an individual, with the method of claim 1, characterized in that it comprises:
a screen (3, 103, 203) displaying an at least two dimensional area and points distributed over said area;
means (8) for drawing segments to connect pairs of said points by means of connection lines to be displayed on said screen;
an electronic processing unit (1) with a memory (2, 3, 4, 5, 6, 7) containing the algorithms for generating the at least two-dimensional space and for generating the coordinates of the different locations, the algorithms for generating a graphical representation of the at least two-dimensional area and of the individual points, the algorithms for drawing the point connecting segments and for displaying said connecting segments on the screen, the algorithms for determining the total length of the drawn segments and the algorithms for pure mathematical computation of all the point connecting segments, in a connection sequence which minimizes the total length of said segments, as well as a possible algorithm (103, 203) for alternately or adjacently displaying all the point connecting segments, as obtained from the algorithm for computing the reference solution, and as set by the individual in the graphical/visual solving attempt.

44. The apparatus of claim 43, characterized in that it comprises means for overlapped display of all the drawn successive point connecting segments and all the computed successive point connecting segments, the segments from the two different sets, i.e. the drawn set and the computed set being highlighted in different manners, e.g. in different colors, and the congruent connecting segments from the two solutions being highlighted, for instance with two-color, double or three color segments.

45. The apparatus of claim 43, characterized in that it also includes memories containing one or more programs for determining a quantitative differentiation index between the drawn and the computed sets of segments and/or between corresponding total lengths.

46. The apparatus of claim 43, characterized in that it includes memories containing interpretation criteria based on empirically or experimentally established data tables, and means for comparing the differentiation index with said interpretation tables.

47. The apparatus of claim 43, characterized in that it includes a memory or a memory section designed for collecting and storing the sets of segments drawn by a uniquely identified individual when graphically solving different problems with different point distributions, there being provided algorithms for determining an average differentiation index based on the individual differentiation indexes between the drawn set and the computed set, as determined during the execution of the different successive tests.

48. The apparatus of claim 43, characterized in that it includes memories containing data for characterizing the typical data of the individual which have a potential influence on the test execution and may used to define parameters for weighting the differentiation indexes to account for any particular specific skills of the individual in extreme conditions.

49. The apparatus of claims 43, characterized in that all the means consist of a personal computer and typical devices therefor.

50. The apparatus of claim 43, characterized in that it includes means (8) for highlighting the two points to be connected and means (1) for automatically drawing the segment connecting the two highlighted points.

51. The apparatus of claim 43, characterized in that the display means consist of a screen of the so-called Touch-screen type, i.e. having the additional function of an input device, operated by the touch of a hand or a tool on the screen.

52. The apparatus of claim 43, characterized in that it is an apparatus for performing Alzheimer disease screening or monitoring tests as claimed in claim 41.

53. The apparatus of claim 1, characterized in that it is an apparatus for implementing the method in business applications as claimed in claim 42.

54. The method of claim 1, characterized in that it is a method for screening or monitoring neurological and/or psychiatric disturbances, such as autism or the like.

55. The method of claim 43, characterized in that it is an apparatus for screening or monitoring neurological and/or psychiatric disturbances, such as autism or the like.

56. The method of claim 1, characterized in that it includes several evaluation steps, each being based on the comparison between the proposed by the individual and a different solution computed by means of one of the various possible best solution computation algorithms, and/or a different best solution among the existing solutions, the comprehensive evaluation consisting of a combination of said evaluation steps, possibly appropriately weighted.

57. The method of claim 1, characterized in that several parameters may be provided, alternatively or in combination, for comparing the solution proposed by the individual with the best reference solution, which solutions may be, alternatively or in combination, the number of crossovers or hits through one point, the solving time, the path segment drawing order, the determination of the areas of polygons defined by drawn segments and by crossovers and/or the determination of the total-area of the surface enclosed by the drawn path, as well as comparisons between said two area values or other characteristics of the solution to be parametrized graphically or mathematically.
